(19) United States
(12) Patent Application Publication
(10) Pub. No.: US 2026/0074131 A1
(43) Pub. Date: Mar. 12, 2026

(54) Electrical Connection Box

(71) Applicant: Yazaki Corporation, Tokyo (JP)

(72) Inventors: Kazuyuki Kawashita, Kakegawa-shi (JP); Masayo Matsuura, Kakegawa-shi (JP)

(21) Appl. No.: 19/389,781

(22) Filed: Nov. 14, 2025

Related U.S. Application Data
(63) Continuation of application No. PCT/JP2023/033702, filed on Sep. 15, 2023.

(30) Foreign Application Priority Data
Jun. 14, 2023 (JP) 2023-097655

(51) Int. Cl. H01H 45/04; H01H 45/12; H01H 45/14

(52) U.S. Cl. CPC H01H 45/04; H01H 45/12; H01H 45/14

(57) ABSTRACT

An electrical connection box (1) includes a pair of relays (20A, 20B) disposed with a gap (S) in between, a case (10), and a heat transfer member (70). Each of the pair of relays (20A, 20B) includes a plurality of terminals (51 to 54), and a protruding portion (23) having a shape protruding toward the gap (S) in a vicinity of at least one (51, 52) of the plurality of terminals. The heat transfer member (70) absorbs heat released from the terminal and transfers the heat in a direction away from the terminal.

### CROSS-REFERENCE TO RELATED APPLICATIONS

This is a continuation of International Application No. PCT/JP2023/033702 filed on September 15, 2023, and claims priority from Japanese Patent Application No. 2023-097655 filed on June 14, 2023, the entire content of which is incorporated herein by reference.

### TECHNICAL FIELD

The present invention relates to an electrical connection box in which a relay is accommodated in a case.

### BACKGROUND ART

An electrical connection box used in an automobile or the like in the related art is configured such that electronic components such as a relay and a fuse are attached to a case made of resin or the like and having a prescribed shape, and input and output terminals of the electronic components are electrically connected to a busbar held in the case, terminals connected to external loads, and the like (for example, see Patent Literature 1).

### CITATION LIST

### PATENT LITERATURE

Patent Literature 1: JP2005-158479A

### SUMMARY OF INVENTION

### TECHNICAL PROBLEM

In the above-mentioned type of electrical connection box, however, when the electronic components (particularly the relay and the fuse) are operated, Joule heat is usually generated in electrified portions such as the input and output terminals of the electronic components due to the flow of a current. In particular, at a contact between an input and output terminal of an electronic component and a busbar or the like connected to the input and output terminal, Joule heat larger than that at other portions may be generated due to a magnitude of contact resistance. Since the heat generated in the contact is also transferred to an internal mechanism of the electronic component via the input and output terminal, it is desirable to efficiently dissipate the heat generated in the contact to the outside of the electronic component

from a viewpoint of appropriately operating the electronic component for a long period of time.

An object of the present invention is to provide an electrical connection box having excellent heat dissipation from a relay accommodated in a case of the electrical connection box.

### SOLUTION TO PROBLEM

To achieve the object described above, the electrical connection box according to the present invention is characterized as follows.

An electrical connection box includes:

a pair of relays disposed with a gap in between;

a case accommodating the pair of relays; and

a heat transfer member disposed in the case, in which

each of the pair of relays includes a plurality of terminals connected to an internal circuit of the relay, and a protruding portion having a shape protruding toward the gap in a vicinity of at least one of the plurality of terminals, and

the heat transfer member absorbs heat released from the at least one terminal and transfers the heat in a direction away from the at least one terminal.

### BRIEF DESCRIPTION OF DRAWINGS

FIG. 1 is a perspective view of an electrical connection box according to an embodiment of the present invention.

FIG. 2 is a top view of the electrical connection box illustrated in FIG. 1.

FIG. 3 is an enlarged view of a portion B in FIG. 2.

FIG. 4 is a bottom view of the electrical connection box illustrated in FIG. 1 (only busbars and electronic components (relays and fuses) are illustrated).

FIG. 5 is an enlarged bottom view of the relays illustrated in FIG. 4.

FIG. 6 shows an internal circuit of a pair of relays illustrated in FIG. 4.

### DESCRIPTION OF EMBODIMENTS

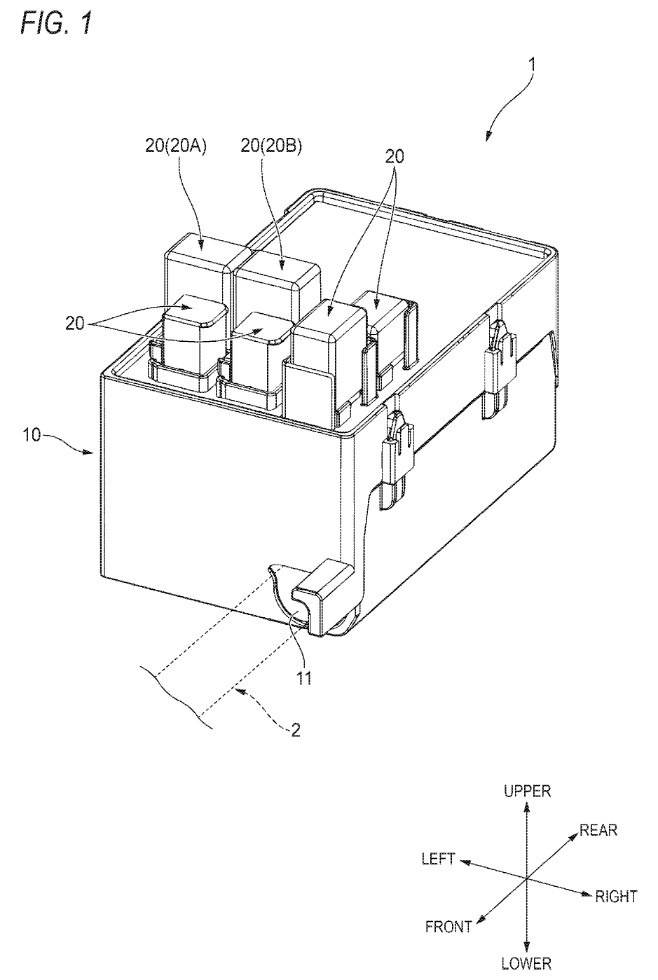

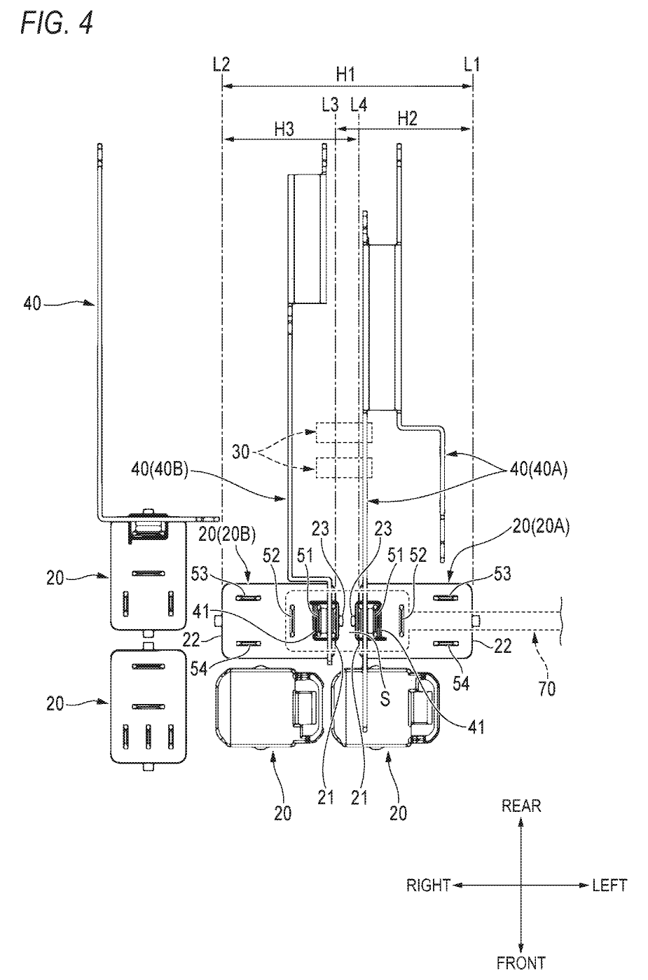

Hereinafter, an electrical connection box 1 according to an embodiment of the present invention will be described with reference to the drawings. The electrical connection box 1 is typically a relay box that is mounted on a vehicle such as an automobile and accommodates electronic components such as relays and fuses. As illustrated in FIGS. 1 to 6, the electrical connection box 1 includes a case 10, a plurality of electronic components (specifically, relays 20 and fuses 30 (see FIG. 4)) accommodated in the case 10, and a plurality of busbars 40 (see FIG. 4) held by the case 10.

Hereinafter, for convenience of description, "front", "rear", "left", "right", "upper", and "lower" are defined as illustrated in FIG. 1 or the like. A front-rear direction, a left-right direction, and an upper-lower direction are orthogonal to one another. An "upper" side and a "lower" side respectively coincide with an "upper" side and a "lower" side of the vehicle in a state in which the electrical connection box 1 is mounted on the vehicle. These directions are defined merely for convenience of description, and do not necessarily correspond to a front-rear direction, a left-right direction, and an upper-lower direction of the vehicle when the electrical connection box 1 is mounted on the vehicle. Hereinafter, components constituting the electrical connection box 1 will be described in order.

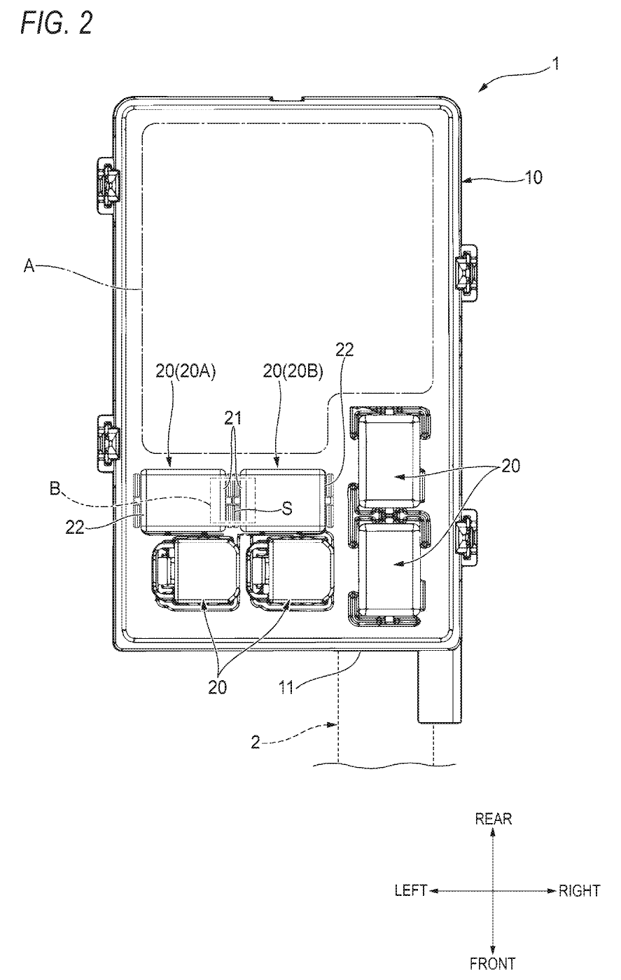

As illustrated in FIGS. 1 and 2, the case 10 is a substantially rectangular parallelepiped resin housing extending in the front-rear direction, the left-right direction, and the upper-lower direction. The case 10 may be formed of a single resin molded body or be formed by combining a plurality of resin molded bodies. In the case 10, a part requiring insulation such as a part holding the electronic components or the busbars 40 may be made of resin, and the other part (for example, an exterior part) may be made of metal.

As illustrated in FIGS. 1 and 2, a plurality of relays 20 are accommodated in a front region of an upper portion of the case 10. Each of the plurality of relays 20 is accommodated in a corresponding accommodation portion (cavity) of the upper portion of the case 10 from an upper side to a lower side. A rear region A (see FIG. 2) adjacent to a rear side of the front region of the upper portion of the case 10 is a region in which the electronic components such as the fuses 30 (see FIG. 4) are accommodated. The fuses 30 or the like are also accommodated in corresponding accommodation portions (cavities) of the upper portion of the case 10 from the upper side to the lower side.

The case 10 is provided with an electric wire insertion portion 11 at a lower right end of a front surface thereof (see FIGS. 1 and 2). From the electric wire insertion portion 11, electric wires 2 electrically connected to the busbars 40 and the electric wires 2 electrically connected to the electronic components such as the relays 20 and the fuses 30 extend forward from the inside to the outside of the case 10 (see FIGS. 1 and 2).

As illustrated in FIG. 4, each of the plurality of busbars 40 held by the case 10 is an elongated metal plate having a prescribed shape when viewed in the upper-lower direction. Each of the plurality of busbars 40 is installed and held from the lower side to the upper side at a corresponding prescribed portion of a lower portion of the case 10 such that a plate thickness direction coincides with a direction orthogonal to the upper-lower direction (such that a plate surface faces the direction orthogonal to the upper-lower direction). As a result, each of the plurality of busbars 40 is electrically connected to an input terminal or an output terminal of one or a plurality of corresponding electronic components (relays 20, fuses 30, and the like), so that the plurality of electronic components (relays 20, fuses 30, and the like) are electrically connected to the electric wires 2 (see FIGS. 1 and 2) via the plurality of busbars 40.

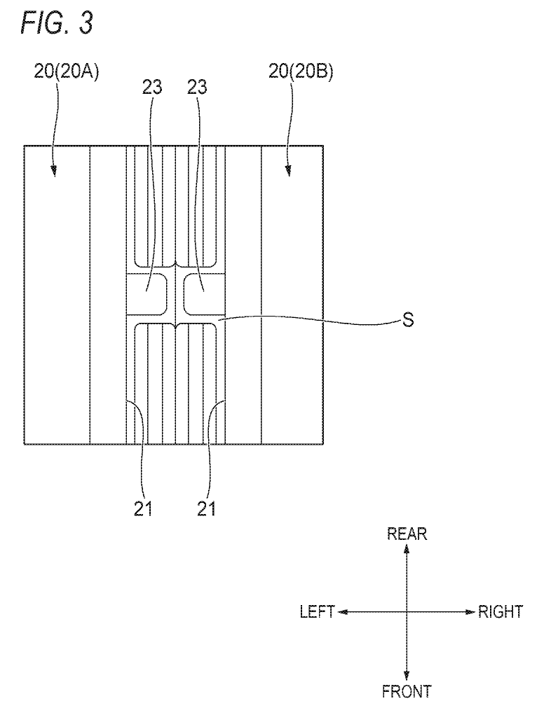

Hereinafter, a pair of relays 20A, 20B (see FIGS. 1 to 5) among the plurality of relays 20 will be focused on. The pair of relays 20A, 20B are relays for a low-voltage circuit in the present example, and may also be relays for a high-voltage circuit depending on embodiments. As illustrated in FIGS. 1 to 5, a resin relay body of each of the pair of relays 20A, 20B has a substantially rectangular parallelepiped shape extending in the front-rear direction, the left-right direction, and the upper-lower direction. The relay bodies of the pair of relays 20A, 20B are arranged side by side in the left-right direction with a gap S (see FIGS. 2 to 4) in between in the left-right direction. For this reason, the relay body of each of the pair of relays 20A, 20B has a quadrangular shape having one side face 21 facing the gap S and an opposite side face 22 opposite to the one side face 21 when viewed from an accommodation direction (upper-lower direction) of the relay 20 into the case 10. The one side face 21 of each of the pair of relays 20A, 20B is provided with a protruding portion 23 protruding toward the gap S (see FIGS. 3 to 5). In the present example, the protruding portions 23 of the pair of relays 20A, 20B are disposed such that protruding ends thereof face each other with a gap in between in the left-right direction.

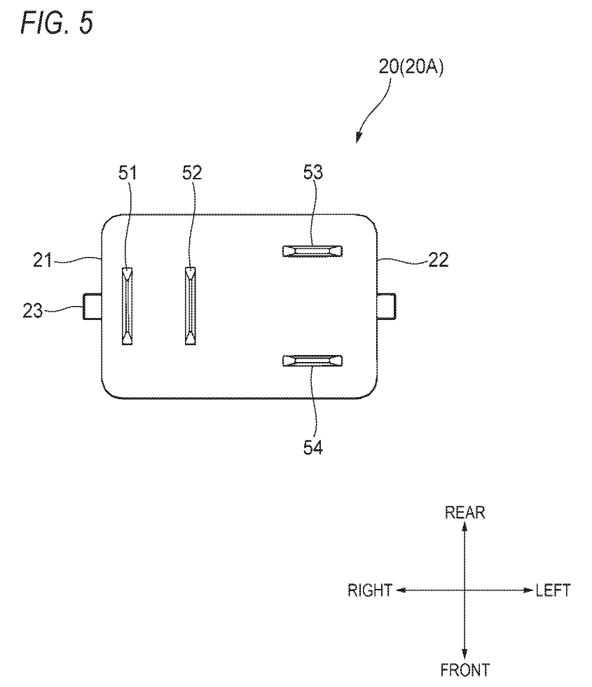

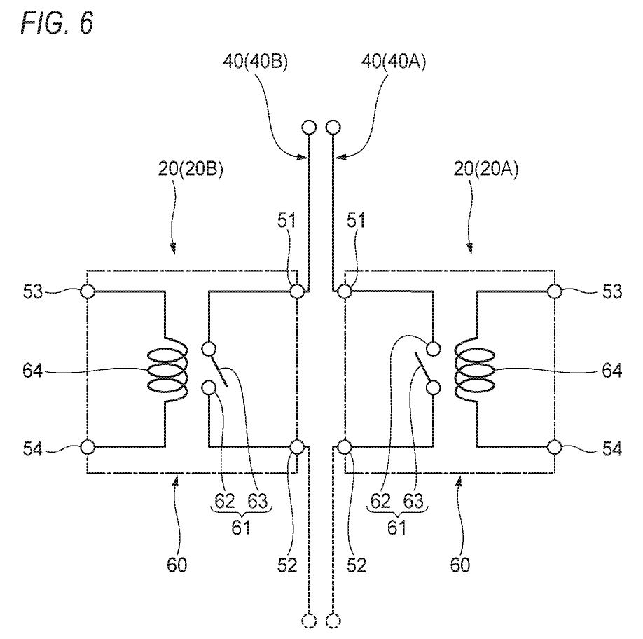

Each of the pair of relays 20A, 20B includes a plurality of terminals 51 to 54 (see FIGS. 4 to 6) connected to an internal circuit 60 (see FIG. 6) provided in the relay body. Each of the plurality of terminals 51 to 54 is a flat plate-shaped (tab-shaped) metal terminal protruding downward from a lower end surface of the relay body of each of the pair of relays 20A, 20B. In the present example, as illustrated in FIGS. 4 and 5, the two terminals 51, 52 face each other with an interval in between in the left-right direction in a region closer to the one side face 21 provided with the protruding portion 23 than to a center of the relay body in the left-right direction. In other words, the protruding portion 23 is disposed in a vicinity of the two terminals 51, 52 of the plurality of terminals 51 to 54. The two terminals 53, 54 face each other with an interval in between in the front-rear direction in a region closer to the opposite side face 22 than to the center of the relay body in the left-right direction.

The terminals 51 of the relays 20A, 20B function as, for example, input-side contact terminals. Specifically, the busbar 40A is connected to the terminal 51 of the relay 20A via a connection terminal 41, and the busbar 40B is connected to the terminal 51 of the relay 20B via the connection terminal 41. Electric wires, which are not illustrated, connected to an external power supply, which is not illustrated, are connected to the busbars 40A, 40B. On the other hand, the terminals 52 of the relays 20A, 20B function as output-side contact terminals, for example. Specifically, electric wires, which are not illustrated, connected to an external load, which is not illustrated, are connected to the terminal 52 of the relay 20A and the terminal 52 of the relay 20B. Each of the busbars 40A, 40B has a shape that includes a part bent in a crank shape when viewed in the upper-lower direction and extends substantially in the front-rear direction.

As illustrated in FIG. 6, the internal circuit 60 of each of the pair of relays 20A, 20B includes a switch portion 61. The switch portion 61 includes a fixed contact 62 and a movable contact 63, and is connected to the terminals 51, 52. The switch portion 61 is provided with a biasing member such as a spring which is not illustrated, and the movable contact 63 is biased by the biasing member in a direction away from the fixed contact 62.

The internal circuit 60 includes a coil portion 64 that includes a coil, an iron core which is not illustrated, and the like and functions as an electromagnet. The coil portion 64 is connected to the terminals 53, 54. The terminals 53, 54 function as coil terminals. The coil portion 64 generates a magnetic force when being supplied with a control current via the terminals 53, 54, and attracts the movable contact 63 against a biasing force of the biasing member by the magnetic force. Accordingly, when the coil portion 64 is supplied with a current, in the switch portion 61, the movable contact 63 comes into contact with the fixed contact 62, and the switch portion 61 is in a closed state (ON). Conversely, when the coil portion 64 is not supplied with a current, in the switch portion 61, the movable contact 63 is separated from the fixed contact 62, and the switch portion 61 is in an open state (OFF).

Operation of the pair of relays 20A, 20B is controlled by, for example, an electronic control unit (ECU) which is not illustrated. When the control current is supplied from the ECU to the coil portion 64 of the relay 20A via the terminals 53, 54 and the switch portion 61 of the relay 20A is in the closed state, power from an external power supply is supplied to an external load via the relay 20A. When the control current is supplied to the coil portion 64 of the relay 20B via the terminals 53, 54 and the switch portion 61 of the relay 20B is in the closed state, power from the external power supply is supplied to the external load via the relay 20B.

In the electrical connection box 1 described above, each of the pair of relays 20A, 20B accommodated in the case 10 includes the protruding portion 23 protruding toward the gap S between the relays 20A, 20B. With the protruding portions 23, the pair of relays 20A, 20B are not disposed excessively close to each other, and the appropriate gap S is present between the pair of relays 20A, 20B. Further, the protruding portion 23 is disposed in the vicinity of the two terminals 51, 52 of each of the pair of relays 20A, 20B. Since the gap S is present between the pair of relays 20A, 20B, Joule heat generated in each of the terminals 51, 52 of the relays 20A, 20B is not concentrated in an excessively narrow range, and heat dissipation is promoted by the flow of air through the gap S. Therefore, the electrical connection box 1 has excellent heat dissipation from the relays 20A, 20B accommodated in the case 10. In addition, as compared with a case where heat generated in each of the terminals 51, 52 is dissipated to different portions, the heat generated in each of the terminals 51, 52 is collectively dissipated to the gap S, which can also contribute to a reduced size of the electrical connection box 1.

Further, the pair of relays 20A, 20B are disposed such that the protruding portion 23 of the relay 20A and the protruding portion 23 of the relay 20B are not in contact with each other. Accordingly, the gap between the pair of relays 20A, 20B can be widened as compared with a case where the protruding portions 23 are in contact with each other.

Further, the protruding portion 23 of the relay 20A is not in contact with the relay 20B, and the protruding portion 23 of the relay 20B is not in contact with the relay 20A. Accordingly, the gap S between the pair of relays 20A, 20B can be widened as compared with a case where each of the protruding portions 23 is in contact with the counterpart relay 20.

Further, the protruding portion 23 is disposed in the vicinity of two terminals 51, 52 among the plurality of terminals 51 to 54. Accordingly, Joule heat generated in the two terminals 51, 52 of each of the relays 20A, 20B can be appropriately dissipated.

Further, the protruding end (right end) of the protruding portion 23 of the relay 20A is closer to the relay 20B than to the terminal 51 of the relay 20A, and the protruding end (left end) of the protruding portion 23 of the relay 20B is closer to the relay 20A than to the terminal 51 of the relay 20B. Accordingly, the terminal 51 of the relay 20A can be reliably disposed in a position away from the relay 20B, and the terminal 51 of the relay 20B can be reliably disposed in a position away from the relay 20A. Therefore, Joule heat generated in the terminals 51 can be appropriately dissipated.

Further, the protruding portion 23 is provided on the one side face 21 of the relay body of each of the relays 20A, 20B which faces the gap S. Accordingly, a shape of the protruding portion 23 can be simplified as compared with a case where the protruding portion 23 protrudes toward the gap S from the other side face of the relay body. Therefore, manufacturing costs of the relay 20 can be reduced.

Further, the electrical connection box 1 may be provided with, as indicated by a broken line in FIG. 4, a heat transfer member 70 that absorbs heat released from at least one terminal (terminals 51, 52 in FIG. 4) of the terminals 51 to 54 of the pair of relays 20A, 20B and transfers the heat in a direction away from the terminal. The heat transfer member 70 is formed of, for example, a metal plate, and extends from the vicinity of the terminals 51, 52 toward the outside of the case 10. The heat transfer member 70 is also referred to as a heat dissipation component. Accordingly, the heat dissipation from the relays 20A, 20B accommodated in the case 10 can be further improved.

From a viewpoint different from the above-described improvement in heat dissipation, as illustrated in FIG. 4, each of the busbar 40A connected to the terminal 51 of the relay 20A and the busbar 40B connected to the terminal 51 of the relay 20B has a shape in which the entire busbars 40A, 40B are located within a range H1 in the left-right direction sandwiched between a straight line L1 extending in the front-rear direction and virtually extending the opposite side face 22 of the relay 20A and a straight line L2 extending in the front-rear direction and virtually extending the opposite side face 22 of the relay 20B when viewed from the accommodation direction (upper-lower direction) of the relays 20 into the case 10. In other words, the busbars 40A, 40B are arranged to fall within a minimum width (that is, inside the range H1) in the left-right direction required for the case 10 to accommodate the pair of relays 20A, 20B.

Arrangements of the electronic components (fuses 30 or the like) different from the relays 20 are designed based on the arrangements of the busbars 40A, 40B within the range H1. In the example illustrated in FIG. 4, arrangements of the two fuses 30 are designed such that the two fuses 30 are connected to the busbar 40A based on the arrangement of the busbar 40A connected to the terminal 51 of the relay 20A. As a result, it is considered that the electrical connection box 1 is easy to have a reduced size as a whole as compared with a case where the busbars 40A, 40B are spread over the entire case 10.

Further, the busbar 40A connected to the relay 20A has a shape in which the entire busbar 40A is located within a range H2 sandwiched between the straight line L1 extending in the front-rear direction and virtually extending the opposite side face 22 of the relay 20A and a straight line L3 extending in the front-rear direction and virtually extending the one side face 21 of the relay 20B when viewed from the accommodation direction (upper-lower direction) of the relay 20. In other words, the busbar 40A is arranged to fall within the range H2 narrower than the range H1.

Similarly, the busbar 40B connected to the relay 20B has a shape in which the entire busbar 40B is located within a range H3 sandwiched between the straight line L2 extending in the front-rear direction and virtually extending the opposite side face 22 of the relay 20B and a straight line L4 extending in the front-rear direction and virtually extending the one side face 21 of the relay 20A when viewed from the accommodation direction (upper-lower direction) of the relay 20. In other words, the busbar 40B is arranged to fall within the range H3 narrower than the range H1.

In this manner, it is considered that the size of the electrical connection box 1 can be further reduced by further specifying the arrangements of the busbars 40A, 40B to fall within the range H2 and the range H3.

Further, the busbars 40A, 40B are connected to the power input terminals 51 of the relays 20A, 20B, respectively. Accordingly, the electrical connection box 1 can have a reduced size even when the large and thick busbars 40A, 40B are adopted to use the terminals 51 for inputting power to the relays 20A, 20B.

The present invention is not limited to the embodiment described above, and various modifications can be adopted within the scope of the present invention. For example, the present invention is not limited to the embodiment described above, and modifications, improvements, and the like can be appropriately made. In addition, materials, shapes, sizes, numbers, arrangement portions, and the like of components in the embodiment described above are freely selected and are not limited as long as the present invention can be implemented.

Here, in the above-described embodiment of the present invention, an electrical connection box (1) includes:

a pair of relays (20A, 20B) disposed with a gap (S) in between;

a case (10) accommodating the pair of relays (20A, 20B); and

a heat transfer member (70) disposed in the case (10), wherein

each of the pair of relays (20A, 20B) includes a plurality of terminals (51 to 54) connected to an internal circuit (60) of the relay, and a protruding portion (23) having a shape protruding toward the gap (S) in a vicinity of at least one (51, 52) of the plurality of terminals (51 to 54), and

the heat transfer member (70) absorbs heat released from the at least one terminal (51, 52) and transfers the heat in a direction away from the at least one terminal (51, 52).

According to the electrical connection box having the above configuration, each of the pair of relays accommodated in the case includes the protruding portion protruding toward the gap between the relays. With the protruding portions, the pair of relays are not disposed excessively close to each other, and an appropriate gap is present between the pair of relays. Further, the protruding portion is disposed in the vicinity of the at least one terminal of the relay. Since the gap is present between the pair of relays, Joule heat generated in the terminal of each relay is not concentrated in an excessively narrow range, and heat dissipation is promoted by the flow of air through the gap. Further, the heat dissipation from the relay accommodated in the case can be further improved by the heat transfer member that absorbs the heat released from the at least one terminal and transfers the heat in the direction away from the terminal. Therefore, the electrical connection box having this configuration is excellent in heat dissipation from the relay accommodated in the case. In addition, as compared with a case where the heat generated in each terminal is dissipated to different portions, the heat generated in each terminal is collectively dissipated to the above-described gap, which can also contribute to a reduced size of the electrical connection box.

Further, the pair of relays (20A, 20B) may be disposed such that the protruding portion (23) of one (20A) of the relays and the protruding portion (23) of another one (20B) of the relays are not in contact with each other.

According to the electrical connection box having the above configuration, the pair of relays are disposed such that the protruding portion of the one relay and the protruding portion of the other relay are not in contact with each other. Accordingly, the gap between the pair of relays can be widened as compared with a case where the protruding portions are in contact with each other.

Further, the protruding portion (23) of one (20A) of the relays may not be in contact with another one (20B) of the relays, and the protruding portion (23) of the other one (20B) of the relays may not be in contact with the one relay (20A).

According to the electrical connection box having the above configuration, the protruding portion of the one relay is not in contact with the other relay, and the protruding portion of the other relay is not in contact with the one relay. Accordingly, the gap between the pair of relays can be widened as compared with a case where each of the protruding portions is in contact with the counterpart relay.

Further, the protruding portion (23) may be disposed in a vicinity of two terminals (51, 52) of the plurality of terminals (51 to 54).

According to the electrical connection box having the above configuration, the protruding portion is disposed in a vicinity of two terminals of the plurality of terminals. Accordingly, Joule heat generated in the two terminals of the relay can be appropriately dissipated.

Further, a protruding end of the protruding portion (23) of one (20A) of the relays may be closer to another one (20B) of the relays than to the at least one terminal (51) of the one relay (20A),

and a protruding end of the protruding portion (23) of the other relay (20B) may be closer to the one relay (20A) than to the at least one terminal (51) of the other relay (20B).

According to the electrical connection box having the above configuration, the protruding end of the protruding portion of the one relay is closer to the other relay than to the at least one terminal of the one relay. The same applies to the protruding portion of the other relay. Accordingly, the terminal of the one relay can be reliably disposed in a position away from the other relay, and the terminal of the other relay can be reliably disposed in a position away from the one relay. Therefore, Joule heat generated in each terminal can be appropriately dissipated.

Further, the protruding portion (23) may be provided on a side face (21) of each of the pair of relays (20A, 20B) which faces the gap (S) as the vicinity of the at least one terminal (51, 52).

According to the electrical connection box having the above configuration, the protruding portion is provided on the side face of each of the relays which faces the gap between the pair of relays. Accordingly, a shape of the protruding portion can be simplified as compared with a case where the protruding portion protrudes toward the gap from the other side face. Therefore, manufacturing costs of the relay can be reduced.

The present application is based on a Japanese patent application (JP2023-097655A) filed on June 14, 2023, and contents thereof are incorporated herein by reference.

### INDUSTRIAL APPLICABILITY

The electrical connection box of the present invention has excellent heat dissipation from a relay accommodated in a case of the electrical connection box. The present invention having this effect can be used, for example, as a relay box mounted on an automobile or the like.

### REFERENCE SIGNS LIST

1 electrical connection box

10 case

20A relay

20B relay

21 one side face (side face)

23 protruding portion

51 to 54 terminal

60 internal circuit

70 heat transfer member

S gap

1. An electrical connection box comprising:
a pair of relays disposed with a gap in between;
a case accommodating the pair of relays; and
a heat transfer member disposed in the case, wherein:
each of the pair of relays includes a plurality of terminals connected to an internal circuit of the relay, and a protruding portion having a shape protruding toward the gap in a vicinity of at least one of the plurality of terminals; and
the heat transfer member absorbs heat released from the at least one terminal and transfers the heat in a direction away from the at least one terminal.

2. The electrical connection box according to claim 1, wherein
the pair of relays are disposed such that the protruding portion of one of the relays and the protruding portion of another one of the relays are not in contact with each other.

3. The electrical connection box according to claim 1, wherein:
the protruding portion of one of the relays is not in contact with another one of the relays; and
the protruding portion of the other relay is not in contact with the one relay.

4. The electrical connection box according to claim 1, wherein
the protruding portion is disposed in a vicinity of two terminals of the plurality of terminals.

5. The electrical connection box according to claim 1, wherein:
a protruding end of the protruding portion of one of the relays is closer to another one of the relays than to the at least one terminal of the one relay; and
a protruding end of the protruding portion of the other relay is closer to the one relay than to the at least one terminal of the other relay.

6. The electrical connection box according to claim 1, wherein
the protruding portion is provided on a side face of each of the pair of relays which faces the gap as the vicinity of the at least one terminal.
